(19) United States
(12) Patent Application Publication
(10) Pub. No.: US 2026/0364606 A1
(43) Pub. Date: Nov. 19, 2026

(54) LIFTING LINER FOR A ROTARY TUBE MILL

(71) Applicant: Magotteaux International S.A., Vaux-sous-Chèvremont (BE)

(72) Inventor: Xavier PRIGNON, Evelette (BE)

(21) Appl. No.: 19/135,712

(22) PCT Filed: Jan. 26, 2024
(86) PCT No.: PCT/EP2024/051936

§ 371 Date: Jun. 4, 2025

(30) Foreign Application Priority Data
Feb. 3, 2023 (EP) 23154911.4

(51) Int. Cl. B02C 17/22

(52) U.S. Cl. CPC B02C 17/22

(57) ABSTRACT

A lifting liner is intended to form part of the covering of the inner wall of the shell of a rotary mill containing a load of grinding implements. The liner has a cylindrical outer face that matches the inner surface of the shell, and rows comprising deflector elements and rows without deflector elements. The deflector elements have a protruding radial profile oriented inwards, perpendicularly to the surface of the shell. The deflector elements form a continuous ring of zigzag shape with an angle alpha>0° with respect to a plane perpendicular to the generatrix of the mill.

### BACKGROUND

Horizontal-axis rotary mills are well known in the prior art in the mining industry, and more particularly in cement production. These mills are equipped with lifting liners for wet and dry grinding. They rotate about a horizontal axis and generally contain steel balls, of variable dimensions. The material to be ground is introduced on one side of the mill and, as it progresses towards the outlet, it is crushed and ground between the grinding implements which are lifted by the deflector elements of the liner as the mill rotates.

Such mills equipped with their liners are described in particular in documents EP0998353A1; BE1011286A3; BE09301481; WO0197975A; U.S. Pat. Nos. 3,869,091A; 6,951,315 B2.

A conventional horizontal-axis rotary mill is generally divided, in the axial direction, by means of a diametral partition wall, into two or three successive chambers. The first chamber, in which coarse crushing of the material takes place, contains grinding balls which generally have a diameter of between 60 mm and 100 mm. The second chamber, in which fine grinding takes place, generally comprises a classifying liner containing grinding balls with a diameter generally between 15 mm and 60 mm.

### SUMMARY

The liner according to the present disclosure is a lifting liner intended for the first chamber of a mill. Its performance is measured mainly in terms of its lifting capacity, while minimizing the rate of wear, which is generally measured in mm per 1000 hours of operation. The present disclosure discloses a lifting liner for the first chamber of a horizontal-axis rotary tube mill comprising a cylindrical shell intended to contain material to be ground and a load of grinding implements (balls, cylindrical pebbles, spherical pebbles). The liner comprises rows of elements with deflectors and elements without deflectors, and the elements without deflectors are only intended to protect the shell and the elements with deflectors are intended to lift the grinding bodies. The lifting capacity of the elements with deflectors may be adapted according to the material to be ground.

The aim of the present disclosure is to produce a lifting liner having great flexibility in terms of use owing to its many possible configurations, the wear of the base plate of the liner not being linked to the wear of the deflector. The deflector, which is subject to significant wear, may optionally be replaced individually without it being necessary to replace the entire liner when the latter is configured in two parts with a base and a deflector mounted removably.

The lifting effect is obtained by a continuous ring of deflectors creating lifting corridors. The deflectors are arranged in a “zigzag”, in parallel or not in parallel. This arrangement makes it possible, with a “zigzag” accentuated to a greater or lesser extent and a carefully selected distance between two rings of deflectors, to meet a wide variety of needs with single modular elements.

The present disclosure relates to a lifting liner intended to form part of the covering of the inner wall of the shell of a rotary mill containing a load of grinding implements, said liner comprising a cylindrical outer face that matches the inner surface of the shell, and rows comprising deflector elements and rows without deflector elements, the deflector elements having a protruding radial profile oriented inwards, perpendicularly to the surface of the shell, characterized in that said deflector elements form a continuous ring of zigzag shape characterized by an angle alpha >0°, with respect to a plane perpendicular to the generatrix of the mill.

The preferred embodiments of the present disclosure comprise at least one, or any appropriate combination of the following features:
the angle alpha ranges between 5 and 25°, preferably between 1° and 25° and particularly preferably between 1° and 21.8°;
the liner elements comprising deflectors have two parts, a base and a deflector removably attached to its base;
the height of the deflectors represents between 0.5 and 4 times, preferably between 1 and 2 times the diameter of the grinding implements;
the distance between the continuous rings in a zigzag is constant by virtue of a parallel arrangement of the rings with respect to one another;
the distance between the continuous rings in a zigzag is variable and preferably the continuous rings in a zigzag are in a position in opposition to one another;
the height of the deflector represents between 1 and 2 times its width.

### DEFINITIONS

In the present disclosure, “continuous” ring means that the deflectors are positioned one after the other so as to form a line in a continuous zigzag but made up of separate components. The deflectors are therefore not in direct contact with one another at the junction between two base plates of the liner but are generally spaced apart by a few millimeters, this small space depending on the tolerances which are always necessary in ironworks.

### BRIEF DESCRIPTION OF THE DRAWINGS

Tables 1 and 2 below summarize the information in FIGS. 1 to 11 which show examples of possible configurations. These examples are only intended to illustrate the present disclosure and are in no way limiting.
The angle alpha (10; 15; 21.8°) is the angle formed by the deflector with a plane perpendicular to a generatrix of the mill. The greater the angle alpha, the greater the lifting capacity of the deflector, all other things being equal.
The “position” (parallel; opposite) describes the arrangement of the continuous rings in a zigzag with respect to one another, for example parallel or not or alternatively in “opposition”.
The length of the pitch of the deflector (314 mm and 628 mm); see figure below.
The distance between rows of deflectors (500 and 750) is the distance between the continuous rings of deflectors arranged in a zigzag; the plates comprising deflectors are in each case separated by one or two rows of liner plates not comprising deflectors.

TABLE 2

| | Angle alpha | | Pitch of the | Distance |
|---|---|---|---|---|
| | of the | | deflector | between rows of |
| FIG. | deflector (°) | Position | (mm) | deflectors (mm) |
| 1 | 15 | parallel | 314 | 500 |
| 2 | 15 | parallel | 314 | 750 |
| 3 | 15 | opposite | 314 | 500 |
| 4 | 15 | opposite | 314 | 750 |
| 5 | 15 | parallel | 628 | 500 + 100 mm |
| | | | | balls |
| 6 | 15 | parallel | 628 | 750 |
| 7 | 15 | opposite | 628 | 500 + 100 mm |
| | | | | balls |
| 8 | 15 | opposite | 628 | 750 |
| 9 | 21.8 | parallel | 314 | 500 |
| 10 | 10 | parallel | 628 | 500 |
| 11 | 10 | opposite | 628 | 500 |

| | | |
|---|---|---|
| 12 | 15 | Attachment system |

FIG. 12 describes a system for attachment of the removable deflector to its base plate. The screw attaches the deflector to its base plate, which is itself attached to the shell of the horizontal-axis mill.

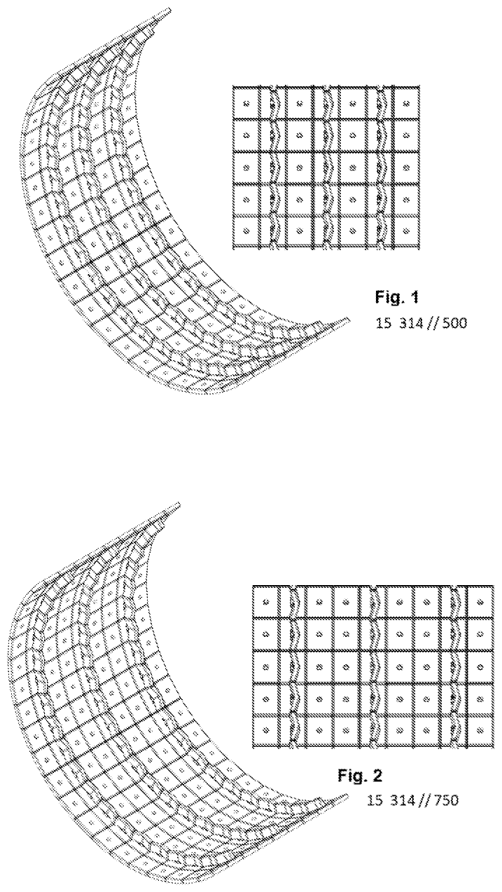

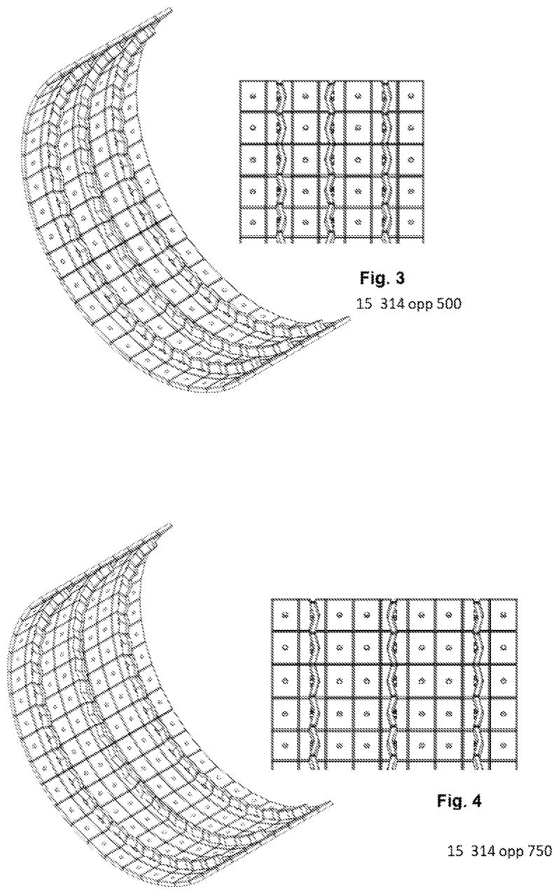

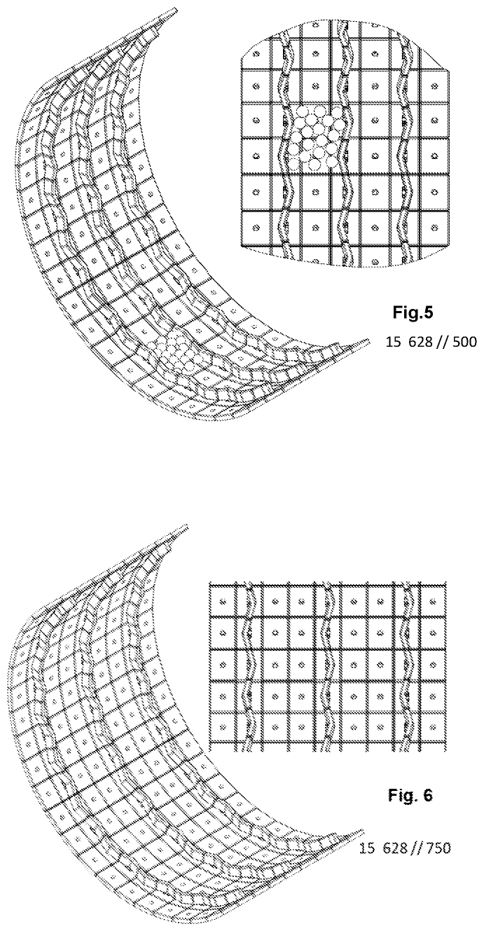

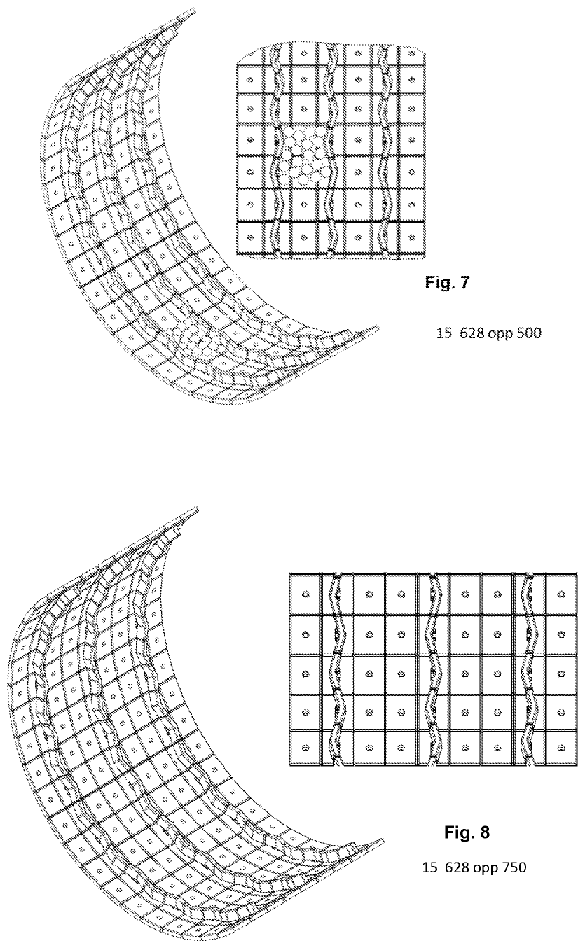

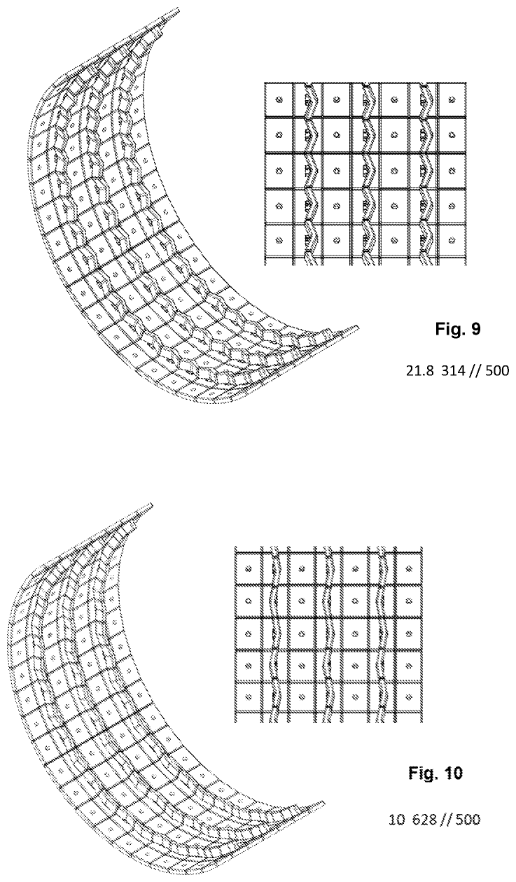

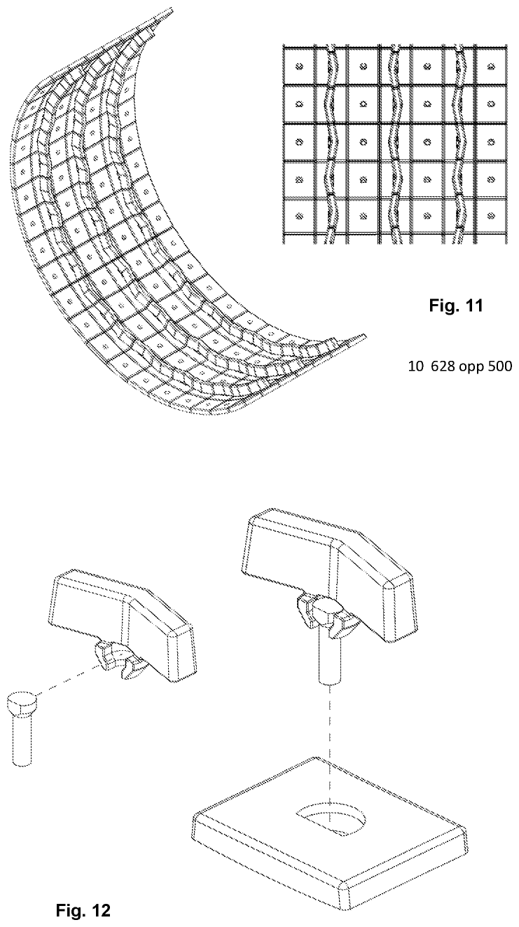

### DETAILED DESCRIPTION

The energy required to grind an ore depends on its particle size and on how crushable it is, and when significant crushing energy is required, significant lifting of the load is necessary, and the lifting profile must therefore be accentuated. When the mill is rotating, this causes most of the grinding balls to be thrown up, and they therefore rain down and become relatively ineffective for the purpose of crushing.

A conventional lifting liner equipped with lifting plates comprising radial protrusions wears down on average at a rate of 1 mm per 1000 hours of grinding for applications in cement production. In the case of some ores, this rate can be much higher. This wear is however not uniform, being around 1.8 mm/1000 hours of operation on the protrusions, whereas it is only around 0.4 mm/1000 hours of operation in the hollows of the plate. This is why performance in terms of lifting, and therefore grinding, falls significantly at the end of service life, requiring replacement of the entire liner even though this liner is still at around 40% of its initial weight and the “used weight” of the liner thus represents only 60%.

In light of the above, the aim of the present disclosure is thus to disassociate the function of lifting from that of protection of the shell. The wear of the liner elements not provided with deflectors has no bearing on lifting capacity, their function being purely to protect the shell. The idea is therefore to combine elements without deflectors with elements equipped with deflectors. This makes it possible to considerably increase the used weight of the liner before replacement to up to 75% of its initial weight and hence, accordingly, to increase the service life of the liner.

For liner elements configured in two parts which comprise a base and a deflector mounted removably, in some cases it is possible to replace just the deflector which affects the lifting capacity, even when its base has already been subjected to considerable wear.

The liner according to the present disclosure therefore comprises a combination between plates, which are generally flat and smooth, intended to protect the shell against wear, and plates equipped with deflectors which form a continuous ring and ensure lifting of the grinding bodies, generally steel balls measuring 60 to 100 mm in diameter. (See for example FIGS. 5 and 7, shown with 100 mm grinding balls.)

The liner plates comprising the deflectors are arranged in such a way that they form a plurality of continuous rings with a greater or lesser distance between them and having a configuration in a “zigzag” which is accentuated to a greater or lesser extent and described by an angle alpha formed between the deflector and the plane perpendicular to a generatrix of the mill. (See FIGS. 1, 9 and 10 for example, which show three different angles.)

The parameters which mainly influence the lifting capacities of the liner according to the present disclosure are:
The distance between the continuous rings of deflectors arranged in a zigzag, and thus ultimately the number of liner plates equipped with deflectors.
The accentuation of the zigzag by an angle alpha of between 5 and 25°, preferably between 1° and 25°; the angle is measured with respect to a plane perpendicular to a generatrix of the mill.
The arrangement of the continuous rings in a zigzag with respect to one another, for example parallel or not parallel or alternatively in “opposition”.
The height of the deflector in direct relation to the diameter of the grinding balls used. For grinding balls measuring 100 mm, the height of the deflector generally ranges from 80 mm to 200 mm (in general, between 0.5 and 4 times, preferably between 0.8 and 2 times, the maximum diameter of the grinding ball).

The liner according to the present disclosure has a wide variety of possible configurations and hence great flexibility of use. Some ores require considerable lifting capacities with a high number of deflector elements, with a great height and with a high angle alpha, as opposed to other ores for which the working conditions are less demanding with fewer rows of plates equipped with deflectors and a lower angle alpha.

The diameter of the grinding balls used, in the new state, generally ranges from 50 to 125 mm, preferably 60 to 90 mm, and the height of the deflectors must be proportional to the diameter of the balls used and must represent between 0.5 and 4 times, preferably between 0.8 and 2 times, the maximum diameter of the grinding balls used.

The heights of the deflectors generally range from 40 to 200 mm, preferably between 60 and 160 mm, and the width from 50 to 90 mm. The distance between two continuous rings in a zigzag may range between 200 and 800 mm, preferably between 500 and 750 mm, and will be adapted according to the length of the first chamber of the mill. The length of the liner plates may vary, and the length of 314 mm shown in the examples corresponds to a DIN standard (DIN 24111) so as to take into account their attachment system.

The shells of the mills are thus drilled with a certain number of holes allowing the passage of the bolts for attachment of the liner plates. Both the configuration of the drilled holes and their diameter vary depending on the manufacturer of the mill. To date, DIN is the only standard imposed in western Europe and is characterized by a longitudinal distance of the holes of 250 mm and a circumferential distance of 314.16 mm in an arc. The diameter of the holes ranges from 30 to 42 mm depending on the manufacturer and the size of the mill.

When the deflector and the base plate are made as a single piece, the system according to the present disclosure makes it possible to replace only the plates with deflectors, when the latter are worn. However, the deflector may also be removably attached to its base, which generally has a thickness ranging between 30 and 80 mm, depending on the desired service life. This removable attachment allows replacement of the deflector alone as it is this that ensures lifting, whereas the wear of the base or of the liner elements without deflectors has a minimal impact on the grinding performance, while the shell of the mill is protected.

### Advantages

Since the lifting of the grinding bodies is created by friction on the lateral faces of the continuous rings in the shape of a zigzag and not by radial protrusions, the advantages of the liner according to the present disclosure are as follows:
the wear on the rings does not substantially modify the angle alpha of the ring segments, which makes it possible to maintain the same level of lifting of the load and constant performance over time;
the continuous rings in a zigzag do not throw the balls towards the foot of the load, and grinding is therefore more efficient, with fewer impacts between the grinding balls and the liner plates;
in the configuration in two parts with deflectors which are removable and hence individually replaceable, it is possible to increase the thickness of the base plates of the liner, which makes it possible to increase the useful part thereof for resisting wear and hence the overall service life. This also makes it possible to reduce the fraction of weight of liner lost when the liner is at the end of its service life. In this case, the deflectors may be replaced one or more times before the base plates wear out.

The liner according to the present disclosure also affords two additional major advantages:
With a base plate and a type of lifter it is possible to have more than eight different liner configurations making it possible to cover practically all variations of lifting currently needed for good crushing of the majority of the products treated in ball mills for cement production (see table above).

### EXAMPLES

Crushing of products ranging from fine and soft (for example crushed limestone <4 mm, with a configuration 15°/314/parallel/750) to the coarsest and hardest (for example molten clinker >100 mm with a configuration 15°/628/opposite/500), with as average lifting Portland clinker (<40 mm with a configuration 15°/628/parallel/500). By increasing the angle alpha of the deflectors, for example to 21.8°, it is possible to achieve equivalent lifting as long as the space between the rings is increased, or by reducing the pitch of the deflectors.
Conversely, if the angle alpha of the deflectors is reduced, equivalent lifting is achieved by reducing the space between rings or increasing the pitch of the deflectors.
The examples given relate to cement production materials but may of course be extrapolated to other materials, in particular in the mining sector, for example for iron ore, gold ore, lead ore or zinc ore, etc.). This flexibility makes it possible to considerably reduce the costs relating to manufacturing and management of liner models, and to standardize the liner plates for customers using different ball mills.
The arrangement of the deflectors in continuous rings over the liner according to the present disclosure has the effect of preferentially retaining the largest, heaviest particles, which are found primarily around the periphery of the load. These large particles will thus stay longer in the first chamber of the grinder and will have a greater likelihood of being crushed properly before moving on to the outlet of the mill.

1. A lifting liner configured to form part of a covering of an inner wall of a shell of a rotary mill containing a load of grinding implements, said liner comprising:
a cylindrical outer face that matches the inner surface of the shell, and
rows comprising deflector elements and rows without deflector elements, the deflector elements each having a protruding radial profile oriented inwards, perpendicularly to the surface of the shell,
wherein said deflector elements of a corresponding row form a continuous ring of zigzag shape having an angle >0°, with respect to a plane perpendicular to a generatrix of the mill.

2. The lifting liner according to claim 1, wherein the angle ranges between 5 and 25°.

3. The lifting liner according to claim 1, wherein the liner deflector elements have two parts, the two parts comprising a base and a deflector removably attached to the base.

4. The lifting liner according to claim 3, wherein a height of each of the deflectors is configured to be between 0.5 and 4 times a diameter of the grinding implements.

5. The lifting liner according to claim 1, wherein a distance between adjacent continuous rings of zigzag shape on different rows is constant by virtue of a parallel arrangement of the rings with respect to one another.

6. The lifting liner according to claim 1, wherein a distance between adjacent continuous rings of zigzag shape on different rows is variable.

7. The lifting liner according to claim 3, wherein a height of each of the deflectors is configured to be between 1 and 2 times a width of the deflector.

8. The lifting liner according to claim 1, wherein the angle is between 1° and 25°.

9. The lifting liner according to claim 1, wherein the angle is between 1° and 21.8°.

10. The lifting liner according to claim 3, wherein a height of each of the deflectors is configured to be between 1 and 2 times a diameter of the grinding implements.

11. The lifting liner according to claim 6, wherein the adjacent continuous rings of zigzag shape are in opposed position to one another.

12. A rotary mill comprising:
a shell, the shell comprising an inner wall,
the inner wall comprising a lifting liner, said liner comprising:
a cylindrical outer face that matches a radially inner surface of the shell,
rows comprising deflector elements and rows without deflector elements, the deflector elements each having a protruding radial profile oriented inwards, perpendicularly to the inner surface of the shell,
wherein said deflector elements form continuous rings of zigzag shape on respective rows, wherein each ring has an angle >0°, with respect to a plane perpendicular to a generatrix of the mill.

13. The rotary mill as claimed in claim 12, wherein the angle is between 5 and 25°.

14. The rotary mill as claimed in claim 12, wherein each one of the deflector elements has two parts, the two parts comprising a base and a deflector removably attached to the base.

15. The rotary mill as claimed in claim 14, wherein a height of the deflector amounts to between 1 and 2 times a width of the deflector.

16. The rotary mill as claimed in claim 12, comprising grinding implements having a diameter, wherein a height of each of the deflectors amounts to between 0.5 and 4 times the diameter of the grinding implements.

17. The rotary mill as claimed in claim 12, wherein a distance between the continuous rings of zigzag shape is constant.

18. The rotary mill as claimed in claim 12, wherein a distance between the continuous rings of zigzag shape is variable.

19. The rotary mill as claimed in claim 12, wherein the angle is between 1° and 21.8°.
